(19) United States
(12) Patent Application Publication
(10) Pub. No.: US 2021/0241949 A1
(43) Pub. Date: Aug. 5, 2021

(54) CAST ALLOY FLAKES FOR R-T-B RARE EARTH SINTERED MAGNET

(71) Applicant: TDK CORPORATION, Tokyo (JP)

(72) Inventor: Akifumi MURAOKA, Chichibu-shi (JP)

(73) Assignee: TDK CORPORATION, Tokyo (JP)

(21) Appl. No.: 17/052,418

(22) PCT Filed: May 7, 2019
(86) PCT No.: PCT/JP2019/018238

§ 371 Date: Nov. 2, 2020

(30) Foreign Application Priority Data
May 17, 2018 (JP) 2018-095547

(51) Int. Cl. H01F 1/057; C22C 37/00

(52) U.S. Cl. CPC H01F 1/0577; C22C 37/00

(57) ABSTRACT

Cast alloy flakes for a R-T-B based rare earth sintered magnet include R (a cast alloy flakes rare earth element), T (a mixture of Fe or Fe and a transition metal (except for Fe and Cu)), M (one or more metals selected from Al, Ga and Cu), and B, wherein R is in the range of 28 to 33% by mass, B is in the range of 0.8 to 1.1% by mass, and M is in the range of 0.1 to 2.7% by mass, and the balance T and impurities. The cast alloy flakes have an area ratio of an R-rich phase in the range of 0.03% to 5% on the roll surface of the cast alloy flakes, or have a content of a coarse R-rich phase having a short axis length of 20 μm or more in the R-rich phase of 20 pieces or less.

### BACKGROUND OF THE INVENTION

### Field of the Invention

This disclosure relates to cast alloy flakes for an R-T-B based rare earth sintered magnet.

Priority is claimed on Japanese Patent Application No. 2018 095547 filed in Japan on May 17, 2018, the contents of which are incorporated herein by reference.

### Description of Related Art

The R-T-B based rare earth sintered magnet is generally a magnet made of an alloy containing R which is a rare earth metal, T which is a transition metal mainly composed of Fe, and B. The R-T-B based rare earth sintered magnets are used in motors such as voice coil motors for hard disk drives and engines motors for hybrid vehicles or electric vehicles.

The R-T-B based rare earth sintered magnet is manufactured by compressing and molding alloy fine powder for the R-T-B based rare earth sintered magnet while applying a magnetic field, and then sintering the obtained molded product. The alloy fine powder for the R-T-B based rare earth sintered magnet is produced by preparing cast alloy flakes for the R-T-B based rare earth sintered magnet by the SC method (strip casting method), and then pulverizing the cast alloy flakes. The SC method is a method in which molten metal, which is a raw material for the R-T-B based rare earth sintered magnet, is poured onto a cooling roll to rapidly cool the molten metal. The cast alloy flakes for the R-T-B based rare earth sintered magnet produced by the SC method have a main phase and an R-rich phase. The main phase is composed of a ferromagnetic R₂T₁₄B phase. The R-rich phase is a nonmagnetic phase in which the concentration of R is higher than that of the main phase.

In order to improve the performance of R-T-B based rare earth sintered magnets, it has been studied to add various elements to the alloy for R-T-B based rare earth sintered magnets and to homogenize the composition of cast alloy flakes for R-T-B based rare earth sintered magnets.

For example, Patent Document 1, filed by the applicant of the present application, discloses an alloy for an R-T-B based rare earth sintered magnet in which one or more metal elements M selected from the group consisting of Al, Ga, and Cu are added. The metal element M described in Patent Document 1 has a function of changing the R₂T₁₇ phase in the alloy into a transition metal-rich phase. The R-T-B based rare earth sintered magnet produced by using the alloy containing the metal element M includes an R-rich phase and a transition metal-rich phase, thereby improving the coercive force.

Patent Document 2, filed by the applicant of the present application, discloses a method for producing cast alloy flakes for R-T-B based rare earth sintered magnets having a uniform composition by the SC method, in which a rotary roll for casting in which a plurality of substantially linear recesses and projections are formed on the cast surface of the roll, the surface roughness given by the substantially linear recesses and projections is set to be 3 μm or more and 60 μm or less in ten-point average roughness (Rz), and the extending direction of the recesses and projections of 30% or more of the substantially linear recesses and projections is set to a direction forming an angle of 30° or more with respect to the roll rotating direction. By using the rotating roll for casting described in Patent Document 2, it is possible to produce cast alloy flakes for an R-T-B based rare earth sintered magnet which suppresses the formation of a fine R-rich phase region and has a structure excellent in homogeneity. The R-T-B based rare earth sintered magnet using the cast alloy flakes for the R-T-B based rare earth sintered magnet has a high homogeneity of the distribution of the R-rich phase and has excellent magnet characteristics.

[Patent Document 1] Japanese Unexamined Patent Application Publication No. 2013-216965

[Patent Document 2] Japanese Unexamined Patent Application Publication No. 2004-181531

### SUMMARY OF THE INVENTION

The R-T-B based rare earth sintered magnets disclosed in the above Patent Documents 1 and 2 are excellent in remanent magnetization and coercive force. However, squareness is sometimes insufficient.

In the present disclosure, a squareness is expressed by the ratio (Hk/iHc) of magnetic field (Hk) and coercive force (iHc) corresponding to 90% of remanent magnetization in a demagnetizing curve.

This disclosure relates to cast alloy flakes for an R-T-B based rare earth sintered magnet which can be used as a material for producing an R-T-B based rare earth sintered magnet having improved squareness while maintaining excellent remanent magnetization and coercive force.

In order to solve the above problems, the present inventors have repeatedly studied and found that cast alloy flakes for an R-T-B based rare earth sintered magnet produced by the SC method tend to form an R-rich phase on a surface in contact with a cooling roll at the time of production (hereinafter, it is sometimes referred to as “roll surface”.), an area ratio of the R-rich phase tends to be higher on the roll surface compared to the surface not in contact with the cooling roll, and a coarse R-rich phase having a short axis length of 20 μm or more tends to be formed. It was confirmed that an R-T-B based rare earth sintered magnet with improved squareness can be obtained by using the cast alloy flakes for the R-T-B based rare earth sintered magnet in which the area ratio of the R-rich phase on the roll surface is within a specific range or the content of the coarse R-rich phase in the R-rich phase is not more than a specific value.

That is, the present invention is as follows.

[1] Cast alloy flakes for an R-T-B based rare earth sintered magnet, comprising:

R which is a rare earth element;

T which is Fe or a mixture of Fe and a transition metal (except for Fe and Cu);

M which is one or more metals selected from the group consisting of Al, Ga, and Cu; and

B,

wherein the cast alloy flakes comprises R in a range of 28% by mass or more and 33% by mass or less;

the cast alloy flakes comprises B in a range of 0.8% by mass to 1.1% by mass;

the cast alloy flakes comprises M in a range of 0.1% by mass to 2.7% by mass;

a remainder consists of T and inevitable impurities;

one surface of the cast alloy flakes is a roll surface; and

an area ratio of a R-rich phase on the roll surface is in a range of 0.03% to 5%.

[2] Cast alloy flakes for an R-T-B based rare earth sintered magnet, comprising:

R which is a rare earth element;

T which is Fe or a mixture of Fe and a transition metal (except for Fe and Cu);

M which is one or more metals selected from the group consisting of Al, Ga, and Cu; and

B,

wherein the cast alloy flakes comprises R in a range of 28% by mass or more and 33% by mass or less;

the cast alloy flakes comprises B in a range of 0.8% by mass to 1.1% by mass;

the cast alloy flakes comprises M in a range of 0.1% by mass to 2.7% by mass;

a remainder consists of T and inevitable impurities;

one surface of the cast alloy flakes is a roll surface; and

when an R-rich phase having a short axis length of 20 μm or more is defined as a coarse R-rich phase, among the R-rich phase on the roll surface, a content of the coarse R-rich phase in the R-rich phase is 20% by number or less.

The disclosure relates to cast alloy flakes for an R-T-B based rare earth sintered magnet which can be used as a material for producing an R-T-B based rare earth sintered magnet having improved squareness while maintaining excellent remanent magnetization and coercive force.

### BRIEF DESCRIPTION OF THE DRAWINGS

FIG. 1 is a schematic diagram of a casting apparatus that can be used for the production of the cast alloy flakes for R-T-B based rare earth sintered magnets of this embodiment.

FIG. 2 is an SEM photograph (reflection electron image) of the roll surface of the cast alloy flakes for the R-T-B based rare earth sintered magnet produced in Example 1.

FIG. 3 is an SEM photograph (reflection electron image) of the roll surface of the cast alloy flakes for the R-T-B based rare earth sintered magnet produced in Comparative Example 1.

### DETAILED DESCRIPTION OF THE INVENTION

Hereinafter, the cast alloy flakes (It is sometimes abbreviated as “cast alloy flakes” below.) for an R-T-B based rare earth sintered magnet according to an embodiment of the present invention will be described in detail. It should be noted that the present invention is not limited to the embodiment described below, and may be implemented by appropriately changing the gist thereof within the scope not changing.

The cast alloy flakes of the present embodiment contain R which is a rare earth element; T which is a mixture of Fe or Fe and a transition metal (except for Fe and Cu); M which is one or more metals selected from the group consisting of Cu, Al, and Ga; and B. The cast alloy flakes of the present embodiment contain R in the range of 28% by mass to 33% by mass, contain B in the range of 0.8% by mass to 1.1% by mass, and contain M in the range of 0.1% by mass to 2.7% by mass, wherein a remainder consists of T and inevitable impurities. One surface of the cast alloy flakes of the present embodiment is a roll surface, and an area ratio of the R-rich phase on the roll surface is in a range of 0.03% to 5%; or when an R-rich phase having a short axis length of not less than 20 μm is defined as a coarse R-rich phase, among the R-rich phases on the roll surface, the content of the coarse R-rich phase in the R-rich phase is 20% by number or less. It is preferable that the roll surface of the cast alloy flakes has an area ratio of the R-rich phase in a range of 0.03% to 5%, and a content ratio of the coarse R-rich phase in the R-rich phase is 20% by number or less.

As R (rare earth element), Sc, Y, La, Ce, Pr, Nd, Pm, Sm, Eu, Gd, Dy, Tb, Ho, Er, Tm, Yb, and Lu may be used. One rare earth element may be used alone, or two or more rare earth elements may be used in combination. Among these rare earth elements, Nd, Pr, Dy, and Tb are particularly preferably used. R preferably contains Nd as a main component. It is particularly preferable that R contains Nd and a rare earth element other than Nd. The rare earth element other than Nd is preferably at least one kind of rare earth element selected from the group consisting of Pr, Dy and Tb. Pr improves the coercivity of the R-T-B based rare earth sintered magnet near room temperature. In addition, Dy and Tb act to improve the coercive force of the R-T-B based rare earth sintered magnet.

The total content (TRE) of R in the cast alloy flakes is in the range of 28% by mass to 33% by mass. When the total content of R is 28% by mass or more, the R2T14B phase of the ferromagnetic phase is easily formed, and the R-T-B based rare earth sintered magnet having an improved coercive force can be obtained.

When the total content of R is 33% by mass or less, the coercive force can be improved without lowering the remanent magnetization of the R-T-B based rare earth sintered magnet. The total content of R is preferably in the range of 29 to 32% by mass.

The content of Nd in R is preferably in a range of 50 to 80% by mass. The content of Pr in R is preferably in the range of 0 to 50% by mass.

The content of Dy and Tb in R is preferably in a range of 0 to 50% by mass in total.

The content of B (Boron) in the cast alloy flakes is in the range of 0.8% by mass to 1.1% by mass. When the content of B is 0.8% by mass or more, the R₂T₁₄B phase of the ferromagnetic phase is easily formed, and an R-T-B based rare earth sintered magnet having an improved coercive force can be obtained. When the content of B is 1.1% by mass or less, the coercive force can be improved without lowering the remanent magnetization of the R-T-B based rare earth sintered magnet. The content of B is preferably in a range of 0.85% by mass to 1.05% by mass.

M is a metal selected from the group consisting of Cu, Al, and Ga. One of these metals may be used alone, or two or more metals may be used in combination. M has an effect of improving coercivity. In addition, M has a function of changing the R₂T₁₇ phase to the transition metal-rich phase in the composition range where the R₂T₁₇ phase is generated in the cast alloy flakes. The R₂T₁₇ phase may cause decrease in the coercivity and squareness of the R-T-B based rare earth sintered magnet. Therefore, by changing the R₂T₁₇ phase to the transition metal-rich phase, an R-T-B based rare-earth sintered magnet having good coercivity and squareness can be obtained.

The content of M in the cast alloy flakes is in the range of 0.1% by mass to 2.7% by mass. If the content of M is less than 0.1% by mass, the coercive force improving effect may not be obtained. When the content of M exceeds 2.7% by mass, the remanent magnetization may decrease.

The content of Cu in the cast alloy flakes is preferably in the range of 0 to 1.0% by mass. The content of Al is preferably in the range of 0 to 0.7% by mass. The content of Ga is preferably in the range of 0 to 1.0% by mass.

T is Fe or a mixture of Fe and a transition metal (except for Fe and Cu). As the transition metal except Fe and Cu, various Group 3 to 11 elements can be used. Specific examples of the transition metal include Co, Zr, and Nb.

Co acts to improve Tc (Curie temperature) and corrosion resistance of R-T-B based rare earth sintered magnets. The content of Co in the cast alloy flakes is preferably in the range of 0 to 5.0% by mass. If the content of Co is too high, it may be disadvantageous in terms of the raw material cost.

Zr and Nb suppress the grain growth of the main phase (R₂T₁₄B phase) during sintering for manufacturing the R-T-B based rare earth sintered magnet, and have the effect of improving the coercivity and squareness of the R-T-B based rare earth sintered magnet. The content of Zr and Nb is preferably in a range of 0 to 2.0% by mass in total. If the content of Zr and Nb is too high, the magnet characteristics of the R-T-B based rare earth sintered magnet may be lowered.

The inevitable impurities contained in the cast alloy flakes are impurities contained in the metal which is the raw material of the cast alloy flakes or impurities inevitably mixed in the manufacturing process. Examples of inevitable impurities include C (Carbon), 0 (oxygen), and N (nitrogen). The content of C in the cast alloy flakes is preferably 0.05% by mass or less. The content of 0 is preferably 0.10% by mass or less. The content of N is preferably 0.01% by mass or less.

In the cast alloy flakes of the present embodiment, the roll surface is a surface in contact with the cooling roll when the cast alloy flakes is manufactured. The roll surface can be confirmed visually or by a reflected electron image of a SEM (scanning electron microscope) because a flaw on the surface of the cooling roll is usually transferred.

The cast alloy flakes of the present embodiment are casting which is produced by the SC method, and the area ratio of the R-rich phase on the roll surface is in the range of 0.03% to 5%. The R-rich phase has the following functions.

(1) In the manufacture of R-T-B based rare earth sintered magnets, the R-rich phase has a melting point lower than that of the main phase and becomes a liquid phase during sintering, which contributes to the densification of the magnets and hence to the improvement of magnetization.

(2) In the R-T-B based rare earth sintered magnet, the R-rich phase reduces the unevenness of grain boundaries, reduces the number of new creation sites in the reverse magnetic domain, and increases the coercive force.

(3) In the R-T-B based rare earth sintered magnet, the R-rich phase magnetically separates the main phase and increases the coercive force.

In the R-T-B based rare earth sintered magnet manufactured by using cast alloy flakes having a large area ratio of the R-rich phase on the roll surface, the dispersion state of the R-rich phase is likely to become uneven, local sintering defects and magnetic deterioration are likely to occur, and squareness tends to decrease. On the other hand, when an R-T-B based rare-earth sintered magnet is manufactured by using cast alloy flakes having a small area ratio of the R-rich phase on the roll surface, it becomes difficult to form a liquid phase during sintering, and it tends to become difficult to obtain a high-density R-T-B based rare-earth sintered magnet.

For this reason, in the cast alloy flakes of the present embodiment, the area ratio of the R-rich phase on the roll surface is set in a range of 0.03% to 5%. The area ratio of the R-rich phase on the roll surface is preferably in the range of 0.2% to 4%, and particularly preferably in the range of 0.5% to 4%. The area ratio of the R-rich phase of the roll surface is the ratio of the total area of the R-rich phase to the area of field of view of the SEM (scanning electron microscope). The total area of the R-rich phase is the total area of the R-rich phase having a short axis length of 1 μm or more. The short axis length of the R-rich phase is a value measured as the length of the short side of a rectangle circumscribing the R-rich phase by using image analysis software.

In the cast alloy flakes of the present embodiment, when the R-rich phase having a short axis length of 20 μm or more is defined as a coarse R-rich phase, the content of the coarse R-rich phase in the R-rich phase is preferably 20% by number or less, that is, the content of the R-rich phase having a short axis length of less than 20 μm is preferably 80% by number or more. By reducing the content of the coarse R-rich phase in the R-rich phase to 20% by number or less, it becomes easy to form a uniform and appropriate liquid phase when manufacturing the R-T-B based rare earth sintered magnet. The content of the coarse R-rich phase is a ratio of the number of coarse rich phases contained in the R-rich phase having a short axis length of 1 μm or more. R-rich phases having a short axis length of 1 μm or more and the number of the coarse R-rich phases can be measured using SEM and image analysis software.

The spacing between the R-rich phases in the cross section (face perpendicular to the roll surface) of the cast alloy flakes is preferably in the range of 2 μm to 5 μm.

The size of the cast alloy flakes is not particularly limited. The thickness of the cast alloy flakes is preferably in the range of 0.1 mm to 0.5 mm.

Next, a method of manufacturing cast alloy flakes of the present embodiment will be described. The cast alloy flakes may be produced by the SC method (strip cast method).

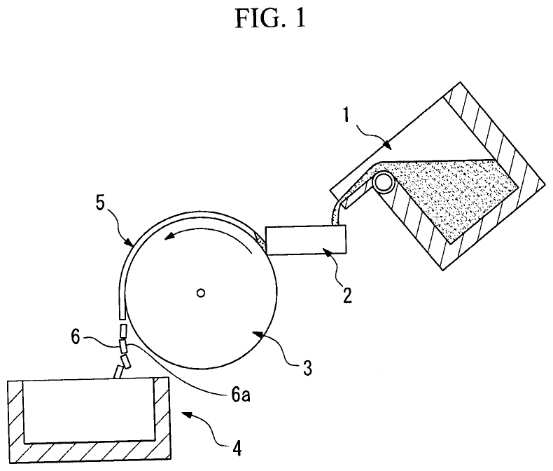

FIG. 1 is a schematic view of a casting apparatus which can be used for producing the cast alloy flakes of the present embodiment.

The casting apparatus has a refractory crucible 1, a tundish 2, a cooling roll 3, and a collection container 4. The tundish 2 has a slag removing mechanism. It is preferable to use copper or a copper alloy as the material of the cooling roll 3 in view of excellent heat conductivity and easy availability.

The R-T-B based alloy is melted in a vacuum or inert gas atmosphere using a refractory crucible 1 due to its active nature. The molten metal of the molten alloy is held at a temperature of 1350° C. or more and 1500° C. or less for a predetermined time, and then supplied to the cooling roll 3 in which the inside is water-cooled through a rectifying mechanism as necessary, and the tundish 2. The alloy 5 (molten metal) supplied on the cooling roll 3 is cooled, separated from the cooling roll 3 on the opposite side of the tundish 2, and recovered as the cast alloy flakes 6 in the collection container 4.

The area ratio and size of the R-rich phase formed on the roll surface 6a (Face in contact with cooling roll 3) of the cast alloy flakes 6 can be adjusted according to the number of revolutions of the cooling roll 3 and the feeding speed of the molten metal to the cooling roll 3. When the size of the R-rich phase formed on the roll surface 6a of the cast alloy flakes 6 is large and the area ratio is large, it is preferable to increase the number of revolutions of the cooling roll 3 and set the feeding speed of the alloy to the cooling roll 3 so that the layer thickness of the alloy 5 fed to the surface of the cooling roll 3 is in a range of 0.1 mm to 0.5 mm. The optimum values of the rotational speed of the cooling roll 3 and the feeding speed of the alloy 5 to the cooling roll 3 cannot be uniformly determined because they vary depending on conditions such as the composition of the R-T-B based alloy, the size and temperature of the cooling roll 3, and the like, but the rotational speed of the cooling roll 3 is preferably in a range of 1.2 m/sec to 3.0 msec as a peripheral speed. The feeding speed of the alloy 5 the cooling roll 3 is preferably in a range of 1.7 kg/min/cm to 3.0 kg/min/cm as an amount per unit contact width (Unit: cm) of the molten metal and the cooling roll 3.

The cast alloy flakes of the present embodiment can be used as a material for manufacturing the R-T-B based rare earth sintered magnet. Next, a method of manufacturing the R-T-B based rare earth sintered magnet using the cast alloy flakes of the present embodiment will be described.

The R-T-B based rare earth sintered magnet can be produced by a method including, for example, a fine powder preparation step of pulverizing the cast alloy flakes to prepare an alloy fine powder, a molding step of compression-molding the obtained alloy fine powder while applying a magnetic field, and a sintering step of sintering the obtained molded body.

As a method of preparing the alloy fine powder in the fine powder preparation step, a method of cracking the cast alloy flakes by a hydrogen cracking method and then pulverizing the obtained cracked product by a pulverizer can be used.

Examples of a method of cracking the cast alloy flakes by a hydrogen cracking method include the following methods. First, the cast alloy flakes are allowed to occlude hydrogen at room temperature, and then heat-treated in hydrogen at a temperature of about 300° C. using a heat-treatment furnace. Next, the pressure in the heat treatment furnace is reduced to remove hydrogen that has entered among the lattice of the main phases of the cast alloy flakes. Thereafter, heat treatment is performed at a temperature of about 500° C. to remove hydrogen bonded to the rare earth element in the grain boundary phase of the cast alloy flakes. Since the cast alloy flakes in which hydrogen are occluded expands in volume, by removing hydrogen from the cast alloy flakes, a large number of cracks are easily generated inside the cast alloy flakes, and the flakes are disintegrated.

A jet mill pulverizer or the like is used as an apparatus for pulverizing the cracked product of the cast alloy flakes after hydrogen-cracking. Specifically, the cracked product of the cast alloy flakes is put into a jet mill pulverizer and pulverized into fine powder, for example, by using high-pressure nitrogen of 0.6 MPa. The average particle size of the alloy fine powder is preferably in a range of 1 μm to 4.5 μm. When the particle size of the alloy fine powder is reduced, the coercive force of the R-T-B based rare earth sintered magnet is improved. However, when the average particle size of the alloy fine powder is excessively reduced, the surface of the alloy fine powder is likely to be oxidized, and conversely, the coercive force of the R-T-B based rare earth sintered magnet may decrease.

As an apparatus for compression-molding the alloy fine powder while applying a magnetic field in the molding process, a molding machine in a transverse magnetic field can be used. In order to improve the formability of the alloy fine powder, a lubricant may be added to the alloy fine powder in advance. As the lubricant, a fatty acid metal salt such as zinc stearate can be used. The amount of the lubricant to be added is preferably in the range of 0.02 to 0.03% by mass.

In the sintering step, the calcination of the molded body is preferably performed in a vacuum. The sintering temperature for sintering the molded article is preferably in the range of 800° C. to 1200° C., and more preferably in the range of 900° C. to 1100° C.

The sintered compact (R-T-B based rare earth sintered magnet) obtained in the sintering step is preferably subjected to heat treatment at a temperature of 400° C. to 950° C. By performing the heat treatment, the structure in the vicinity of the grain boundary is optimized, whereby the R-T-B based rare earth sintered magnet having a higher coercive force can be obtained.

The heat treatments of the R-T-B based rare earth sintered magnet may be performed once, or twice or more.

For example, when the R-T-B based rare earth sintered magnet is subjected to heat treatment once, the heat treatment is preferably performed at a temperature of 450° C. or higher and 550° C. or lower.

When the R-T-B based rare earth sintered magnet is subjected to the heat treatment twice, the heat treatment is preferably carried out at a temperature of 600° C. or higher and 950° C. or lower (first heat treatment) and another temperature of 450° C. or higher and 550° C. or lower (second heat treatment) in two stages. The coercivity of R-T-B based rare earth sintered magnets tends to improve when the heat treatment is performed at two temperatures. It is inferred that this is because, by the first heat treatment, the R-rich phase becomes a liquid phase and wraps around the main phase, and by the second heat treatment, the structure in the vicinity of the grain boundary is optimized and the transition metal-rich phase is easily generated.

Since the area ratio of the R-rich phase on the roll surface of the cast alloy flakes for the R-T-B based rare earth sintered magnet of the present embodiment having the above-described structure is in the range of 0.03% to 5%, the R-rich phase is uniformly dispersed in the R-T-B based rare earth sintered magnet manufactured by using the cast alloy flakes, the R-rich phase is dense, and local sintering defects and magnetic deterioration are unlikely to occur. Therefore, the R-T-B based rare earth sintered magnet manufactured by using the cast alloy flakes for the R-T-B based rare earth sintered magnet of the present embodiment has improved squareness while maintaining excellent remanent magnetization and coercive force.

In addition, when the content of the coarse R-rich phase in the R-rich phase is not more than 20% by number in the cast alloy flakes for the R-T-B based rare earth sintered magnet of the present embodiment, a uniform and appropriate liquid phase is easily formed when the R-T-B based rare earth sintered magnet is manufactured. Therefore, in the R-T-B based rare earth sintered magnet manufactured by using the cast alloy flakes for the R-T-B based rare earth sintered magnet, the dispersion state of the R-rich phase tends to be more uniform, and the squareness tends to be more improved. In the present embodiment, it is preferable that the roll surface of the cast alloy flakes for the R-T-B based rare earth sintered magnet has an area ratio of the R-rich phase in the range of 0.03% to 5%, and the content of the coarse R-rich phase in the R-rich phase is 20% by number or less. However, it is not always necessary to satisfy the both conditions, and it is enough to satisfy at least one of the conditions.

The R-T-B based rare-earth sintered magnet produced by using the cast alloy flakes for the R-T-B based rare-earth sintered magnet of the present embodiment usually has a squareness of 0.90 to 0.95.

In addition, the magnetic characteristics of the R-T-B based rare earth sintered magnet are stabilized, and the variation between products is reduced.

### EXAMPLES

### Example 1 to 5 and Comparative Example 1 to 2

Nd metal (purity: 99% by mass or more), Pr metal (purity: 99% by mass or more), Dy—Fe metal (Dy content: 80% by mass, Fe content: 20% by mass), Tb metal (purity: 99% by mass or more), ferroboron (Fe content 80% by mass, B content 20% by mass), iron (purity: 99% by mass or more), Co metal (purity: 99% by mass or more), Zr metal (purity: 99% by mass or more), Cu metal (purity: 99% by mass), Al metal (purity: 99% by mass or more), and Ga (purity: 99% by mass or more) were weighed and mixed to obtain a raw material mixture as shown in Table 1 below. “TRE” in Table 1 is a total content (% by mass) of rare earth elements, and “bal.” is the balance.

The resulting raw material mixture was loaded into an alumina crucible. The alumina crucible was installed in a high frequency vacuum induction furnace, and the inside of the furnace was replaced with Ar. Then, the inside of the high-frequency vacuum induction furnace was heated to 1450° C., and the raw material mixture was melted to form the molten alloy. The obtained molten alloy was cast by the SC method using the casting apparatus shown in FIG. 1 to produce cast alloy flakes. A water-cooled copper roll was used for the cooling roll of the casting apparatus. The casting was carried out in an Ar atmosphere. The peripheral speed of the cooling roll and the feeding speed (feeding speed per unit contact width of molten metal and cooling roll) of the molten metal to the cooling roll were adjusted to the values shown in Table 2 below.

The cast alloy flakes were then cracked by the following hydrogen cracking method. First, the cast alloy flakes were inserted into hydrogen at room temperature to occlude hydrogen. Then, the cast alloy flakes having absorbed hydrogen were heat-treated in hydrogen at 300° C. using a heat-treatment furnace. Then, the pressure in the heat treatment furnace was reduced to remove hydrogen in the interstitials of the main phase of the cast alloy flakes. Further, heat treatment was performed at a temperature of 500° C. to remove hydrogen in the grain boundary phase of the cast alloy flakes, and then the flakes were cracked by a method of cooling to room temperature.

Next, the cracked product of the cast alloy flakes cracked by hydrogen-cracking was pulverized by a jet mill pulverizer (100 AFG, manufactured by Hosokawa Micron Corporation) using high-pressure nitrogen of 0.6 MPa so as to have an average particle size (d50) of 4.0 μm, whereby an R-T-B based alloy fine powder was obtained.

Then, zinc stearate of 0.02% by mass to 0.03% by mass was added as a lubricant to the obtained fine powder of the R-T-B based base alloy, and the product was formed by press molding using a molding machine in a transverse magnetic field at a molding pressure of 0.8 t/cm².

Thereafter, the molded body was placed in a tray made of carbon and placed in a heat treatment furnace, and the pressure was reduced to 0.01 Pa. Then, heat treatment was performed at 500° C. for the purpose of removing the organic matter, and heat treatment was performed at 800° C. for the purpose of decomposing the hydride. Subsequently, a heat treatment was performed at 1000 to 1100° C. for sintering to obtain a sintered compact, and a first heat treatment was performed at 900° C. for 1 hour and a second heat treatment was performed at 500° C. for 1 hour to obtain an R-T-B based rare-earth sintered magnet.

[Evaluation]

The cast alloy flakes and the R-T-B based rare earth sintered magnet obtained in Example 1 to 5 and Comparative Example 1 to 2 were evaluated as follows.

(1) Composition of Cast Alloy Flakes

The contents of metallic elements (Nd, Pr, Dy, Tb, Co, Zr, Cu, Al, Ga) in the cast alloy flakes were measured by a fluorescence X-ray analyzer (XRF). The content of B was measured by a high-frequency inductively coupled mass spectrometer (ICP-MS). Further, the contents of C, O, and N were measured by a gas analyzer. The results are shown in Table 1 below.

(2) Average Thickness of Cast Alloy Flakes

The thicknesses of 1000 cast alloy flakes were measured using a laser type thickness measuring device. The average is the average thickness of the cast alloy flakes. The results are shown in Table 2 below.

(3) Spacing of R-rich Phases in Cast Alloy Flakes Cross Section

Cast alloy flakes were embedded in a conductive resin, and a cross section (face perpendicular to the roll surface) of the cast alloy flakes was machined, and mirror-polished. Then, the mirror-polished sections of the cast alloy flakes were observed at a magnification of 350 times using a SEM (scanning electron microscope) to obtain reflected electron images. In the reflection electron image of the obtained cross section, the portion appearing white was defined as the R-rich phase. In addition, it was confirmed by the composition map analysis by EPMA (electron microanalyzer) that the portion appearing white was the R-rich phase.

Next, a straight line was drawn on the reflected electron image in parallel with the roll surface of the cast alloy flakes at intervals of 10 μm, and the intervals of the R-rich phase crossing the straight line were measured, and the average value was calculated. The results are shown in Table 2 below.

(4) Area Ratio and Number of R-Rich Phase on Cast Alloy Flakes Roll Surface The roll surface of the cast alloy flakes was observed at a magnification of 50 times using a SEM (scanning electron microscope) to obtain a reflected electron image (field of view: 2.3 mm×1.7 mm). The portion appearing white in the reflected electron image of the roll surface thus obtained was defined as a R-rich phase, and the short axis length of the R-rich phase was measured as the length of the short side of the rectangle circumscribing the R-rich phase by using image analysis software, and the R-rich phase having a short axis length of 1 μm or more was extracted. In addition, it was confirmed by the composition map analysis by EPMA (electron microanalyzer) that the portion appearing white is the R-rich phase.

Then, the area of the extracted R-rich phase was measured to obtain the area of the R-rich phase per field of view. The number of extracted R-rich phases was measured to obtain the number of R-rich phases per field of view. The area ratio of the R-rich phase was calculated from the following equation. The area ratio of the R-rich phase was measured for five cast alloy flakes, and the average value is shown in Table 2.

Area ratio (%) of R-rich phase=(Area of R-rich phase per field of view/area of field of view)×100

(5) Content of Coarse R-rich Phase in R-rich Phase

From the reflected electron image of the roll surface obtained in the above (4), an R-rich phase having a short axis length of 20 μm or more was extracted using image analysis software. The number of extracted coarse R-rich phases was measured to obtain the number of coarse R-rich phases per field of view. Then, using the number of R-rich phases per field of view obtained in the above (4), the content rate of the coarse R-rich phase was calculated from the following equation. The content of the coarse R-rich phase was measured for five cast alloy flakes, and the average value is shown in Table 2.

Content (%) of Coarse R-rich phase =(Number of Coarse R-rich Phases per Field of View/Number of R-rich Phases per Field of View)×100

(6) Br, iHc, and squareness of R-T-B based rare earth sintered magnets Br (remanent magnetization), iHc (coercivity), and squareness of R-T-B based rare earth sintered magnets were measured using a pulsed BH curve tracer (TPM 2-10 manufactured by Toei Industry Co., Ltd).

TABLE 1

| | Alloy composition (% by mass) | | | | | | | | | | | | | | |
|---|---|---|---|---|---|---|---|---|---|---|---|---|---|---|---|
| | R | | | | | T | | | M | | | | Inevitable impurity | | |
| | TRE | Nd | Pr | Dy | Tb | Fe | Co | Zr | Cu | Al | Ga | B | C | O | N |
| Example 1 | 30.5 | 22.5 | 6.5 | 1.5 | 0.0 | bal. | 2.00 | 0.04 | 0.10 | 0.30 | 0.10 | 0.92 | 0.015 | 0.035 | 0.005 |
| Example 2 | 32.6 | 25.7 | 6.9 | 0.0 | 0.0 | bal. | 0.45 | 0.20 | 0.10 | 0.20 | 0.15 | 0.92 | 0.012 | 0.030 | 0.003 |
| Example 3 | 30.3 | 23.7 | 0.0 | 6.6 | 0.0 | bal. | 0.00 | 0.20 | 0.00 | 0.18 | 0.00 | 1.00 | 0.009 | 0.038 | 0.005 |
| Example 4 | 32.8 | 17.8 | 6.0 | 0.0 | 9.0 | bal. | 0.50 | 0.00 | 0.10 | 0.18 | 0.50 | 0.82 | 0.011 | 0.009 | 0.001 |
| Example 5 | 29.5 | 22.2 | 7.3 | 0.0 | 0.0 | bal. | 0.90 | 0.10 | 0.10 | 0.10 | 0.30 | 0.97 | 0.012 | 0.010 | 0.002 |
| Comparative | 30.5 | 22.5 | 6.5 | 1.5 | 0.0 | bal. | 2.00 | 0.04 | 0.10 | 0.30 | 0.10 | 0.92 | 0.015 | 0.035 | 0.005 |
| Example 1 | | | | | | | | | | | | | | | |
| Comparative | 32.6 | 25.7 | 6.9 | 0.0 | 0.0 | bal. | 0.45 | 0.20 | 0.10 | 0.20 | 0.15 | 0.92 | 0.012 | 0.030 | 0.003 |
| Example 2 | | | | | | | | | | | | | | | |

TABLE 2

| | Production conditions | | | | | | | | |
|---|---|---|---|---|---|---|---|---|---|
| | for cast alloy flakes | | | | | | | | |
| | | Feeding | | | | | | | |
| | | speed | | | | | | | |
| | | of | | | | | | | |
| | | molten | | | | | | | |
| | | metal | Evaluation of | | | | | | |
| | | per | cast alloy flakes | | | | | | |
| | | unit | | | Roll | | | | |
| | | contact | | | surface | | | | |
| | | width | | | | Content | | | |
| | | between | | | | of | Evaluation of | | |
| | | cooling | | | | coarse | R-T-B based | | |
| | Peripheral | roll | | Cross- | Area | R-rich | rare earth | | |
| | speed | and | | section | ratio | phase in | sintered magnet | | |
| | of the | molten | | R-rich | of | R-rich | fabricated using | | |
| | cooling | metal | Average | phase | R-rich | phase | cast alloy flakes | | |
| | roll | (kg/min/ | thickness | spacing | phase | (% by | Br | iHc | Square- |
| | (m/sec) | cm) | (mm) | (μm) | (%) | number) | (kG) | (kOe) | ness |
| Example 1 | 1.6 | 2.0 | 0.32 | 4.1 | 3.27 | 17.3 | 13.6 | 17.7 | 0.927 |
| Example 2 | 1.7 | 1.8 | 0.25 | 2.5 | 2.02 | 5.9 | 13.5 | 16.5 | 0.930 |
| Example 3 | 1.9 | 1.9 | 0.24 | 4.5 | 0.56 | 2.1 | 12.9 | 26.5 | 0.922 |
| Example 4 | 1.2 | 1.7 | 0.22 | 2.4 | 1.05 | 3.2 | 11.6 | 53.0 | 0.941 |
| Example 5 | 1.2 | 1.7 | 0.28 | 4.6 | 0.26 | 0.1 | 14.4 | 12.6 | 0.904 |
| Comparative | 1.1 | 1.5 | 0.28 | 3.9 | 8.29 | 27.1 | 13.5 | 17.9 | 0.898 |
| Example 1 | | | | | | | | | |
| Comparative | 1.1 | 1.6 | 0.26 | 2.8 | 7.06 | 22.2 | 13.9 | 14.6 | 0.897 |
| Example 2 | | | | | | | | | |

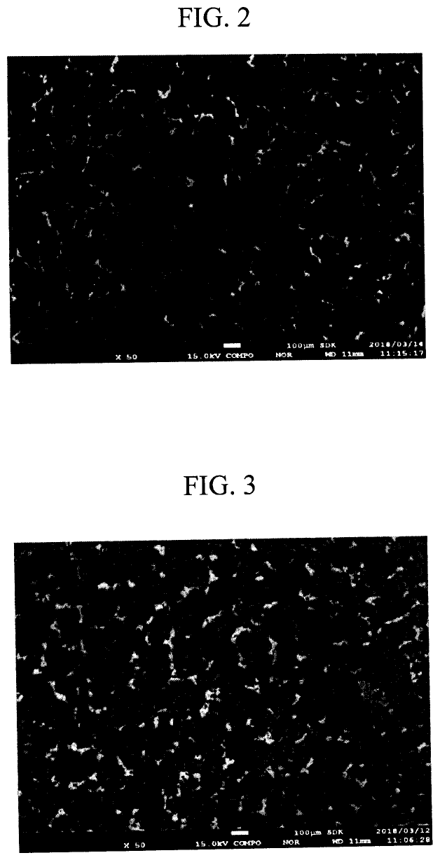

When Example 1 was compared with Comparative Example 1, and Comparative Example 2 was compared with Comparative Example 2; although, as shown in Table 1, the alloy composition was the same, as shown in Table 2, the area ratio of the R-rich phase on the roll surface and the content of the coarse R-rich phase in the case of the cast alloy flakes produced in Examples 1 and 2 were lower than those in the case of the cast alloy flakes produced in Comparative Examples 1 and 2. FIG. 2 shows the reflected electron image of the roll surface of the cast alloy flakes manufactured in Example 1, and FIG. 3 shows the reflected electron image of the roll surface of the cast alloy flakes manufactured in Comparative Example 1.

Comparing FIG. 2 with FIG. 3, it was confirmed that the R-rich phase (area of white vision) formed on the roll surface of the cast alloy flakes produced in Example 1 was thinner and shorter than the R-rich phase formed on the roll surface of the cast alloy flakes produced in Comparative Example 1. Therefore, it is considered that the area ratio of the R-rich phase of the cast alloy flakes manufactured in Example 1 was reduced because the size of the R-rich phase formed on the roll surface was reduced.

Further, the R-T-B based rare earth sintered magnet produced by using the cast alloy flakes of Example 1 to 5 had higher squareness than the R-T-B based rare earth sintered magnet produced by using the cast alloy flakes of Comparative Examples 1 and 2. It is considered that this is because, in Examples 1 and 2, the R-rich phase is uniformly dispersed, the R-rich phase is dense, and the local coercive force is not decreased.

### DESCRIPTION OF THE SIGN

1. Refractory crucible

2. Tundish

3. Cooling roll

4. Collection container

5. Alloy

6. Cast alloy flakes

6a. Roll surface

1-2. (canceled)

3. Cast alloy flakes for an R-T-B based rare earth sintered magnet, comprising:
R which is a rare earth element;
T which is Fe or a mixture of Fe and a transition metal (except for Fe and Cu);
M which is one or more metals selected from the group consisting of Al, Ga, and Cu; and
B,
wherein the cast alloy flakes comprises R in a range of 28% by mass to 33% by mass;
the cast alloy flakes comprises B in a range of 0.8% by mass to 1.1% by mass;
the cast alloy flakes comprises M in a range of 0.1% by mass to 2.7% by mass;
a remainder consists of T and inevitable impurities;
one surface of the cast alloy flakes is a roll surface; and
an area ratio of a R-rich phase on the roll surface is in a range of 0.03% to 5%.

4. The cast alloy flakes for an R-T-B based rare earth sintered magnet according to claim 3,
wherein the cast alloy flakes comprises Cu in a range of 0% by mass to 1.0% by mass;
the cast alloy flakes comprises Al in a range of from 0% by mass to 0.7% by mass; and
the cast alloy flakes comprises Ga in a range of 0% by mass to 1.0% by mass.

5. The cast alloy flakes for an R-T-B based rare earth sintered magnet according to claim 3,
wherein the inevitable impurities comprises oxygen; and
the cast alloy flakes comprises oxygen of 0.10 mass % or less.

6. Cast alloy flakes for an R-T-B based rare earth sintered magnet, comprising:
R which is a rare earth element;
T which is Fe or a mixture of Fe and a transition metal (except for Fe and Cu);
M which is one or more metals selected from the group consisting of Al, Ga, and Cu; and
B,
wherein the cast alloy flakes comprises R in a range of 28% by mass to 33% by mass;
the cast alloy flakes comprises B in a range of 0.8% by mass to 1.1% by mass;
the cast alloy flakes comprises M in a range of 0.1% by mass to 2.7% by mass;
a remainder consists of T and inevitable impurities;
one surface of the cast alloy flakes is a roll surface; and
when an R-rich phase having a short axis length of 20 μm or more is defined as a coarse R-rich phase, among the R-rich phases on the roll surface, a content of the coarse R-rich phase in the R-rich phase is 20% by number or less.

7. The cast alloy flakes for an R-T-B based rare earth sintered magnet according to claim 6,
wherein the cast alloy flakes comprises Cu in a range of 0% by mass to 1.0% by mass;
the cast alloy flakes comprises Al in a range of from 0% by mass to 0.7% by mass; and
the cast alloy flakes comprises Ga in a range of 0% by mass to 1.0% by mass.

8. The cast alloy flakes for an R-T-B based rare earth sintered magnet according to claim 6,
wherein the inevitable impurities comprises oxygen; and
the cast alloy flakes comprises oxygen of 0.10 mass % or less.
